(19) United States
(12) Patent Application Publication
(10) Pub. No.: US 2014/0089029 A1
(43) Pub. Date: Mar. 27, 2014

(54) METHOD AND APPARATUS FOR SCHEDULING MAINTENANCE OF ALTERNATIVE ENERGY SYSTEMS

(71) Applicant: Enphase Energy, Inc., Petaluma, CA (US)

(72) Inventors: Raghuveer R. Belur, Los Altos Hills, CA (US); Martin Fornage, Petaluma, CA (US)

(73) Assignee: Enphase Energy, Inc., Petaluma, CA (US)

(21) Appl. No.: 14/033,996

(22) Filed: Sep. 23, 2013

Related U.S. Application Data
(60) Provisional application No. 61/704,086, filed on Sep. 21, 2012.

(51) Int. Cl. G06Q 10/10

(52) U.S. Cl. CPC G06Q 10/1097
USPC 705/7.21

(57) ABSTRACT

A method and apparatus for optimizing the cost of scheduling maintenance of a distributed energy generator. In one embodiment, the method comprises obtaining information, from a controller, related to impaired operation of at least one component in a distributed energy generator, wherein the distributed energy generator comprises a plurality of components; calculating a cost to restore non-impaired operation of the distributed energy generator; calculating a cost of lost power due to the impaired operation of the distributed energy generator; and determining an optimal time to schedule maintenance of the distributed energy generator based on the calculated cost to restore non-impaired operation and the calculated cost of lost power.

### CROSS-REFERENCE TO RELATED APPLICATIONS

This application claims benefit of U.S. provisional patent application Ser. No. 61/704,086, filed Sep. 21, 2012, which is herein incorporated in its entirety by reference.

### BACKGROUND

1. Field

Embodiments of the present disclosure generally relate to a method and apparatus for the operation and maintenance of alternative energy systems and, more particularly, to determining the optimal time for the scheduling maintenance of commercial and residential applications.

2. Description of the Related Art

Use of distributed generators (DGs) to produce energy from renewable resources is steadily gaining commercial acceptance due to the rapid depletion of existing fossil fuels and the increasing costs of current methods of generating power. One such type of distributed generator is a solar power system. Such solar power systems generally comprise large numbers of photovoltaic (PV) modules that convert received solar power into a direct current (DC). One or more inverters may be coupled to the PV modules for converting the DC current into an alternating current (AC), which may then be used to run appliances at a home or business, or may be sold to a commercial power company.

Variations in energy produced by the PV modules in a solar power system may be attributed to various issues, such as variations in the inverters, variations in power output within a manufacturer's tolerance, damage done to any component of the system, or various obstructions that impede a PV module's access to the sun. Some impediments may be unsolvable, sometimes due to an immovable object obstructing the path of sunlight to the PV module. However, sometimes impediments are solvable and can be remedied by simply cleaning dirt, dust, or a similar substance from the module.

With the use of new technology to display the electrical input and output of each individual part of a DG, an operator or homeowner is able to quickly identify if a part of the DG begins to malfunction. However, it is not always cost effective to immediately attempt to repair a damaged component of a DG. Warranty repairs require a service person to visit the site to fix the problem. This is costly and may be outweighed by the cost of the power lost.

Therefore, there is a need in the art for determining the optimal time for the scheduling maintenance of alternative energy systems.

### SUMMARY

Embodiments of the present invention generally relate to a method and apparatus for optimizing the cost of scheduling maintenance of a distributed energy generator substantially as shown in and/or described in connection with at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a distributed energy generation system in which the cost of scheduling of component maintenance is optimized in accordance with one or more embodiments of the present invention;

FIG. 2 is a block diagram of a controller in accordance with one or more embodiments of the present invention;

FIG. 3 is a block diagram of a scheduler in accordance with one or more embodiments of the present invention; and

FIG. 4 is a flow diagram of a method for optimizing the cost of scheduling maintenance of alternative energy systems, in accordance with one or more embodiments of the present invention.

### DETAILED DESCRIPTION

Embodiments of the present invention generally relate to a method and apparatus for optimizing the cost of scheduling maintenance of alternative energy systems, pertaining, but not limited to, commercial and residential applications of the method and apparatus. Micro-inverter-based DG systems promote an opportunity for a unique operation and maintenance solution. The method eliminates a system-wide single point of failure in a DG system. A failure of any component of a DG is flagged and treated as routine maintenance and not as a catastrophic failure that requires immediate repair. The method determines when an optimal time for repair or replacement of a malfunctioning component occurs, taking into consideration various factors, such as the cost of replacement, the cost of the travel involved to remedy the malfunction, the model of yield per component, and the cost of a replacement component. The method enables energy systems to function at the optimized minimum cost for operation, by reimbursing owners for the loss of energy output until the malfunctioning component is repaired. The method establishes when the balance of the cost to repair outweighs the cost of reimbursement for lost energy, i.e., whether the total cost is minimized by having a problem repaired immediately or whether it is cheaper to continue to reimburse an owner and wait to repair the malfunctioning component at a later time.

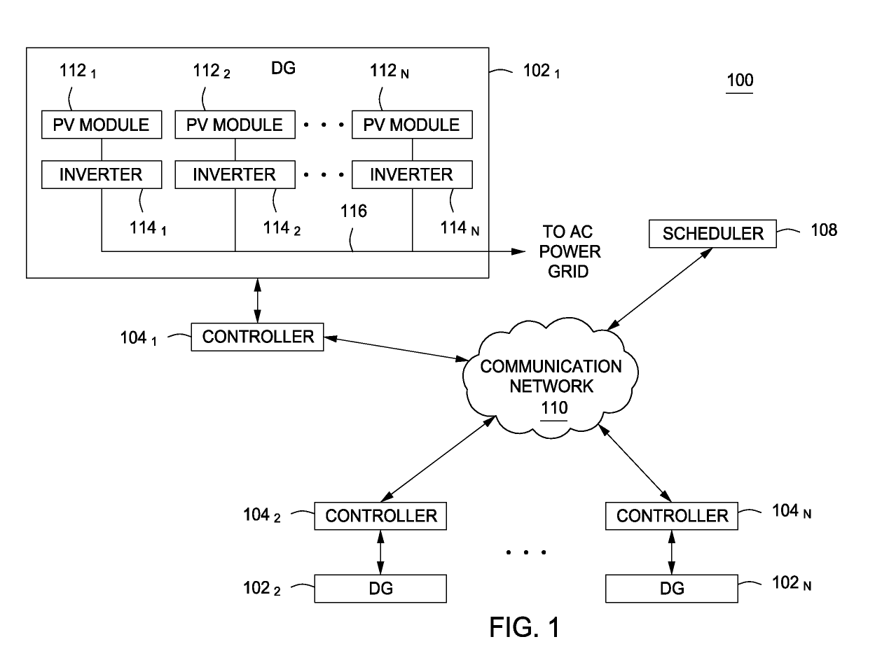

FIG. 1 is a block diagram of a distributed energy generation system 100 in which the cost of scheduling of component maintenance is optimized in accordance with one or more embodiments of the present invention. The system 100 comprises a plurality of distributed generators (DGs) 102₁, 102₂, . . . , 102ₙ, (collectively referred to as DGs 102), a plurality of controllers 104₁, 104₂, . . . , 104ₙ, (collectively referred to as controllers 104), a scheduler 108, and a communications network 110. The DGs 102 each comprise a plurality of PV modules 112₁, 112₂, . . . , 112ₙ, (collectively referred to as PV modules 112) and a plurality of inverters 114₁, 114₂, . . . 114ₙ, (collectively referred to as inverters 114). Each inverter 114₁, 114₂, . . . 114ₙ is coupled to a PV module 112₁, 112₂, . . . 112ₙ, respectively, in a one-to-one correspondence (e.g., as for micro-inverters). The inverters 114 convert DC power from the corresponding PV modules 112 to grid-compliant AC power and are coupled to an AC bus 116, which in turn couples the generated AC power to the AC power grid. The controllers 104 and the scheduler 108 are communicatively coupled via the communications network 110, e.g., the Internet.

The DGs 102 (i.e., distributed energy generators) generate power from solar energy via the PV modules 112, although one or more DGs 102 may additionally or alternatively generate power from other types of renewable resources, such as wind energy, hydroelectric energy, and the like. In some embodiments, a DG 102 is comprised of a plurality of PV modules 112 coupled to one or more inverters 114 (i.e., each inverter 114 is coupled to a plurality of PV modules 112, such as in one or more strings) for inverting the generated DC power to AC power. In some embodiments, a DC/DC converter may be coupled between each PV module 112 and each inverter 114 (e.g., one converter per PV module 112). In some alternative embodiments, multiple PV modules 112 may be coupled to a single inverter 114 (i.e., a centralized inverter 114); in some such embodiments, one or more DC/DC converters may be coupled between the PV modules 112 and the centralized inverter 114.

In some embodiments, the DGs 102 may comprise one or more DC/DC converters coupled to the PV modules 112 (i.e., in place of the inverters 114) for generating a DC current that may be utilized directly or stored, for example, in one or more batteries. In some alternative embodiments, one or more of the DGs 102 may additionally or alternatively comprise a plurality of wind turbines, as in a “wind farm”, or components for generating DC current from any other renewable energy source and/or DC sources such as batteries, as well as one or more DC/DC converters and/or one or more inverters 114.

Each DG 102₁, 102₂, . . . , 102ₙ is coupled to a controller 104₁, 104₂, . . . , 104ₙ, respectively, in a one-to-one correspondence. The controllers 104 collect information regarding the health and performance of components of the DG 102, such as measurements of power generated by one or more components of the DG 102, power consumed from one or more components of the DG 102, deactivation of the components, alarm and alert messages, and the like. Such information may be generated at various levels of granularity; for example, for a DG 102 comprising a solar energy system, the information may be amassed for one or more individual PV modules 112, solar panels, inverters 114 (e.g., micro-inverters), and/or solar arrays, as well as for the entire DG 102. Some or all of the information may be collected periodically or in real-time.

The collected information is communicated from the controllers 104 to the scheduler 108 and may be stored within the scheduler 108, for subsequent data analysis and/or report generation. In some embodiments, some or all of the collected information may be stored within the controller 104, and/or may be communicated in real-time to the scheduler 208. Additionally, the controllers 104 and the scheduler 108 may communicate operational instructions to the DG 102 for operating the DG 102 and its components.

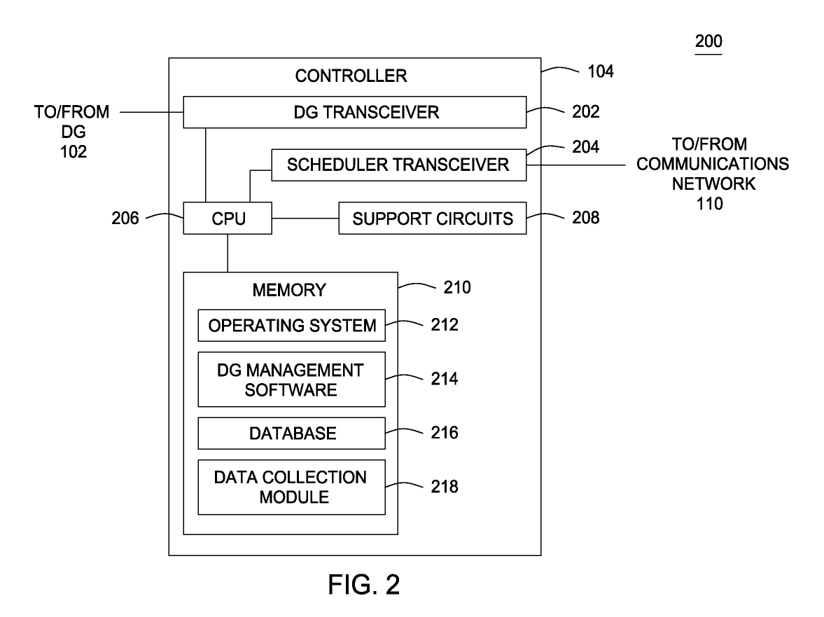

FIG. 2 is a block diagram of a controller 104 in accordance with one or more embodiments of the present invention. The controller 104 comprises a distributed generator (DG) transceiver 202, a scheduler transceiver 204, at least one central processing unit (CPU) 206, support circuits 208, and a memory 210. The CPU 206 is coupled to the DG transceiver 202, the scheduler transceiver 204, the support circuits 208, and the memory 210, and may comprise one or more conventionally available processors, microprocessors, microcontrollers and/or combinations thereof configured to execute non-transient software instructions to perform various tasks in accordance with the present invention. Alternatively, the CPU 206 may include one or more application specific integrated circuits (ASICs). In one or more other embodiments, the CPU 206 may be a microcontroller comprising internal memory for storing controller firmware that, when executed, provides the functionality described herein. The support circuits 208 are well known circuits used to promote functionality of the CPU 206. Such circuits include, but are not limited to, a cache, power supplies, clock circuits, buses, network cards, input/output (I/O) circuits, and the like. The controller 104 may be implemented using a general purpose computer that, when executing particular software, becomes a specific purpose computer for performing various embodiments of the present invention.

The DG transceiver 202 communicates with DG 102, for example to obtain the health and performance information collected from the DG 102 and/or to provide control instructions to the DG 102. In some embodiments, the DG transceiver 202 may be coupled via power lines to one or more inverters 114 within the DG 102, and may communicate with the inverter(s) 114 utilizing Power Line Communications (PLC). Alternatively, the controller 104 may communicate with the inverter(s) 114 utilizing wireless or other wired communication methods, for example a WI-FI or WI-MAX modem, 3G modem, cable modem, Digital Subscriber Line (DSL), fiber optic, or similar type of technology.

The scheduler transceiver 204 communicatively couples the controller 104 to the scheduler 108 via the communications network 110 to facilitate the management of the DG 102 (e.g., for providing the collected health and operational information to the scheduler 108 and/or for receiving control information from the scheduler 108). The scheduler transceiver 204 may utilize wireless or wired techniques, for example a WI-FI or WI-MAX modem, 3G modem, cable modem, Digital Subscriber Line (DSL), fiber optic, PLC, or similar type of technology, for coupling to the network 110 to provide such communication.

The memory 210 may comprise random access memory, read only memory, removable disk memory, flash memory, and various combinations of these types of memory. The memory 210 is sometimes referred to as main memory and may, in part, be used as cache memory or buffer memory. The memory 210 generally stores an operating system 212 of the controller 104. The operating system 212 may be one of a number of commercially available operating systems such as, but not limited to, SOLARIS from SUN® Microsystems, Inc., AIX® from IBM® Inc., HP-UX from Hewlett Packard Corporation, LINUX from Red Hat Software, Real-Time Operating System (RTOS), WINDOWS 2000 from Microsoft Corporation, and the like.

The memory 210 stores non-transient processor-executable instructions and/or data that may be executed by and/or used by the CPU 206. These processor-executable instructions may comprise firmware, software, and the like, or some combination thereof. The memory 210 may store various forms of application software, such as DG management software 214 for managing the DG 102 and its components, as well as a database 216 for storing data pertaining to the DG 102 (e.g., health and performance data from the DG 102). In accordance with one or more embodiments of the present invention, the memory 210 may further comprise a data collection module 218 for collecting operational data pertaining to the DG 102, such as power generated by one or more components of the DG 102, power consumed, fault information, and the like. Such data may be collected and stored at various levels of granularity; for example, for a DG 102 comprising a solar energy system, data may be collected and stored for one or more individual PV modules 112, inverters 114, solar panels, and/or solar arrays, as well as for the entire DG 102.

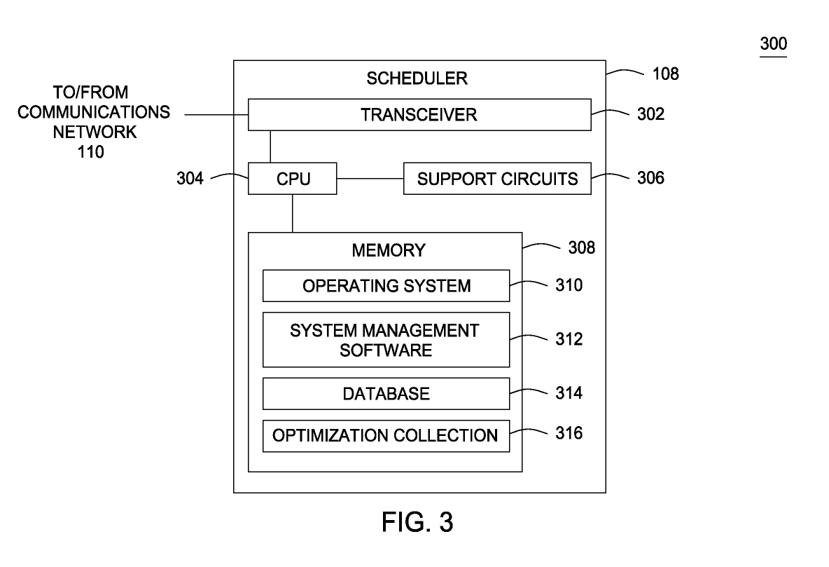

FIG. 3 is a block diagram of a scheduler 108 in accordance with one or more embodiments of the present invention. The scheduler 108 comprises a transceiver 302, support circuits 306, and a memory 308 coupled to at least one central processing unit (CPU) 304. The CPU 304 may comprise one or more conventionally available processors, microprocessors, microcontrollers and/or combinations thereof configured to execute non-transient software instructions to perform various tasks in accordance with the present invention. Alternatively, the CPU 304 may include one or more application specific integrated circuits (ASICs). In one or more other embodiments, the CPU 304 may be a microcontroller comprising internal memory for storing controller firmware that, when executed, provides the functionality described herein. The support circuits 306 are well known circuits used to promote functionality of the CPU 304. Such circuits include, but are not limited to, a cache, power supplies, clock circuits, buses, network cards, input/output (I/O) circuits, and the like. The scheduler 108 may be implemented using a general purpose computer that, when executing particular software, becomes a specific purpose computer for performing various embodiments of the present invention.

The transceiver 302 communicatively couples the scheduler 108 to the controllers 104 via the communications network 110 to monitor and/or provide control to the DGs 102, for example for operating the controllers 104 and/or components of the DGs 102. Additionally, the scheduler 108 receives operational information regarding the DGs 102 via the controllers 104. The transceiver 302 may utilize wireless or wired techniques, for example a WI-FI or WI-MAX modem, 3G modem, cable modem, Digital Subscriber Line (DSL), fiber optic, PLC or similar type of technology, for coupling to the network 110 to provide such communication.

The memory 308 may comprise random access memory, read only memory, removable disk memory, flash memory, and various combinations of these types of memory. The memory 308 is sometimes referred to as main memory and may, in part, be used as cache memory or buffer memory. The memory 308 generally stores an operating system 310 of the scheduler 108. The operating system 310 may be one of a number of commercially available operating systems such as, but not limited to, SOLARIS from SUN® Microsystems, Inc., AIX® from IBM® Inc., HP-UX from Hewlett Packard Corporation, LINUX from Red Hat Software, Real-Time Operating System (RTOS), Windows 2000 from Microsoft Corporation, and the like. The memory 308 stores non-transient processor-executable instructions and/or data that may be executed by and/or used by the CPU 304. These processor-executable instructions may comprise firmware, software, and the like, or some combination thereof.

The memory 308 may store various forms of application software, such as system management software 312, for managing DGs 102 (e.g., for collecting and storing operational information from the DGs 102). The memory 308 also may store various databases, such as a database 314 for storing data related to the system 100. The database 314 may comprise data such as replacement cost data for the various components of the DGs 102, cost of transportation for travel to replace a component of the DGs 102 based on the distance between the DGs 102 and a service center, one or more formulas for determining a cost of transportation for travel to a DG 102 based on the distance between the DG 102 and a service truck's location, price of energy, operational information regarding components of the DGs 102, (e.g., health information; predicted failure rates of components and/or groups of components, such as the DG 102; and the like), one or more thresholds to be compared to the energy yield and/or financial yield from one or more DG components or groups of DG components, one or more thresholds to be compared to a cost equation for determining whether a time t is optimal for maintenance, one or more cost formulas, and the like. All or some of the data stored in the database 314 may be periodically updated.

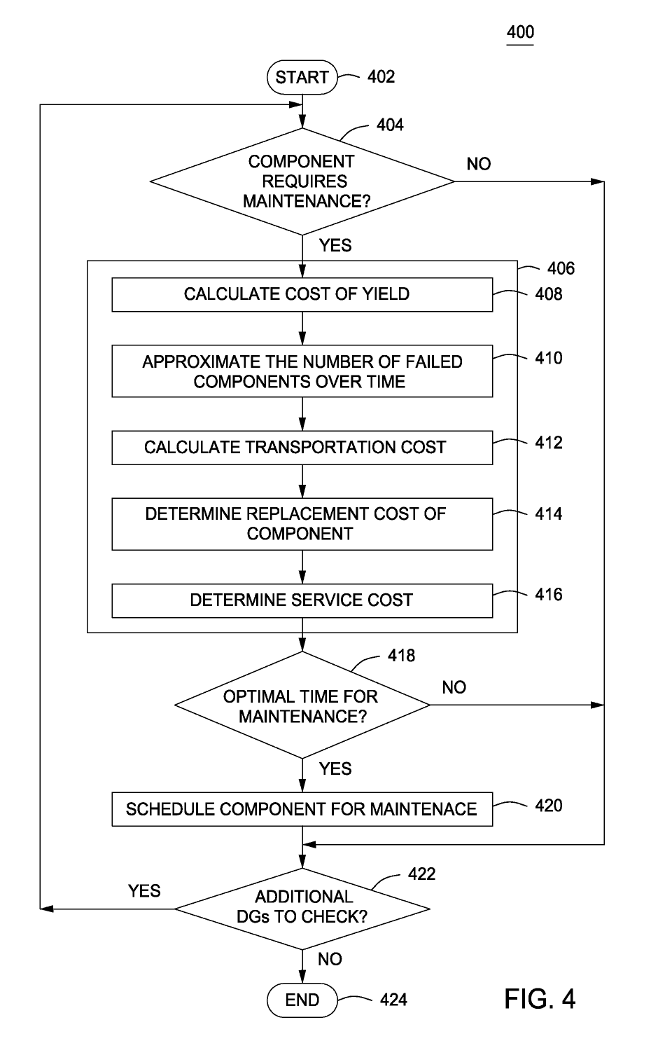

In accordance with one or more embodiments of the present invention, the memory 308 may further store an optimization module 316 for optimizing the scheduling of maintenance of the DGs 102, as described in detail below with respect to FIG. 4. Such schedule optimization allows for the determination of an optimal time to repair or replace a malfunctioning or impaired component of a DG 102, taking into consideration factors such as the financial yield of the DG 102, the predicted failure rate of each DG 102 (e.g., the predicated failure rate of one or more components of the DG 102), a cost of transportation for a travel to repair the DG 102, cost of service for a maintenance visit, and a component replacement or repair cost. In one embodiment, a customer or owner of a DG 102 is financially compensated for lost power due to a malfunctioning DG 102. The cost of compensating the customer for lost power may be less than the cost to repair or replace the component. The optimization module 316 determines the optimal time to perform maintenance on the DG 102 when the cost of such maintenance is minimized. When the optimization module 316 determines that it is the optimal time to perform maintenance on the component, the DG 102 is scheduled for maintenance.

One or more parameters used in determining the optimal maintenance time may be periodically updated or updated in real time; thus the optimization module 316 may dynamically determine the optimal time for maintenance of the DG 102 based on the most current parameters. For example, if an installer is working nearby a DG 102 that has a failed component, the overall cost may be lower to have the component replaced at that time rather than to wait.

FIG. 4 is a flow diagram of a method 400 for optimizing the cost of scheduling maintenance of alternative energy systems, in accordance with one or more embodiments of the present invention. In some embodiments, such as the embodiment described below, operational information for the DG is collected. The operational information is collected by a controller, such as a controller 104 and sent to a scheduler such as the scheduler 108. The method 400 determines when the cost of scheduling maintenance of a DG is minimized and schedules the DG for maintenance when that time arrives.

In some embodiments, a computer readable medium comprises a program that, when executed by a processor, performs the method 400 for optimizing the cost of scheduling maintenance as described in detail below.

The method 400 begins at step 402 and proceeds to step 404. At step 404, operational information for the DGs is accessed and analyzed in order to determine whether any components of the DG are in need of maintenance. The method 400 retrieves the health and operational information from the database 314 of the scheduler 108 that was collected by the controller 104, and determines if any components are in need of maintenance or repair. In some embodiments, if the energy yield for a DG is less than is expected by a given threshold, or zero, then it is determined that maintenance is required. Maintenance may be required to clear an obstruction, or repair and/or replace a malfunctioning or impaired one or more components of the DG. In some alternative embodiments, the method 400 determines the maintenance requirements by obtaining health and operating information in real-time from the controller 104.

If at step 404 it is determined that maintenance is not required, the method 400 proceeds to step 422; otherwise, if it is determined at step 404 that maintenance is required, the method 400 proceeds to step 406. At step 406, the method 400 gathers and calculates data required to determine an optimal time for maintenance. The steps for gathering and calculating data may be performed in any order or in parallel. In an exemplary embodiment, the method 400 at step 408 calculates Yu(t), the financial amount each operating component would yield over time (in dollars), taking into account the cost of kilowatt-hours (kWh) over time, the expected insulation (weather model), and a model for the system harvest which depends on the PV plant construction such as existence of trackers, inverter performance wiring losses, and the like. In some embodiments, Yu(t) may be calculated using off-the-shelf or public domain software.

In some embodiments, the calculated financial amount may be equivalent to the cost of lost power when a component is impaired and is the amount a customer would be reimbursed for lost power while a component is awaiting repair. The cost of lost power is affected by various parameters, such as the time of year (which determines the hours of usable light), weather conditions, and the like.

The method 400 proceeds to step 410, where the method 400 approximates the number of failed components over time using equation (2):

F(t)=N∫₀^{T}f(t)dt
where:
F(t) is the number of failed components over time T,
N is the number of working components, and
f(t) is the probability that a component will fail.

The computed number of failed components over time F(t) may be updated with an actual number of failed units periodically or in real-time.

The method 400 proceeds to step 412, where the method 400 calculates a cost of transportation for travel to a DG for a maintenance visit. The cost of travel may be fixed, or the cost may be dynamically determined based on, for example, a service truck's proximity to a DG. The method 400 proceeds to step 414, where the method 400 accesses information stored in a database, for example database 314, to determine the fixed cost of the component in need of repair or replacement and at step 416 the cost of service for the maintenance visit. In some alternative embodiments, all or some of such information may be received in real-time rather than retrieved from a database.

The method 400 proceeds to step 418, where the method 400 performs an analysis based on the gathered data to determine an optimal time to schedule a maintenance visit for the DG. The analysis compares the cost of reimbursing the customer over time to the cost of repairing/replacing the component over time. The total cost of operation is the total cost of lost energy plus the cost of the repair/replacement of one or more components (i.e., the cost of restoring non-impaired operation) and is determined using equation (3):

T_{C}(T)=∫₀^{T}Yu(t)×F(t)dt+C_{T}+C_{R}×F(t)

where:

T_{c}(T) is the total cost of operation over time T,

Yu(t) is the amount a component yields over t (in dollars),

C_{T} is the cost of travel to the component location,

C_{R} is the cost of replacing the component (time and materials cost), and

F(t) is the number of failed components over time T.

This equation computes the total cost of operation as a factor of the cost of lost energy and cost of repair/replacement, where T is the time of repair/replacement. The minimum run rate occurs when the total cost of operation over time, i.e.,

$$\frac{{T}_{C} ( T )}{T}$$

is minimized.

$$φ = \frac{d [ \frac{{T}_{C} ( T )}{T} ]}{d T}$$

is synthesized in order to solve for the minimum rate.

Optimum timing may not simply be scheduling maintenance at the earliest time possible or determining when the cost of repair/replacement equals the cost of reimbursing the customer. The assessment analyzes the impact of cost savings from delaying repair/replacement based on the probability of one or more components failing or causing other components to fail over time, the cost of transportation for the travel and the repair/replacement, in addition to the fixed cost of the component (i.e., the cost of replacing the component). In one embodiment, the time a maintenance action is optimal is determined using the cost equation (i.e., equation (4):

$$φ = \frac{1}{T} [ {\int }_{O}^{T} Yu ( t ) \times f ( t ) d t ] + Yu ( t ) \times F ( t ) - \frac{{C}_{T}}{T} - \frac{{C}_{R} F ( t )}{T} + {C}_{R} \frac{d F ( t )}{d t}$$

where:

Yu(t) is the amount a component yields over time t (in dollars),

f(t) is the probability that a component will fail over time t,

F(t) is the number of failed components over time t,

C_{T} is the cost of travel to the component location, and

C_{R} is the cost of replacing the component (time and materials cost).

In one embodiment, the time t is optimal when the cost equation (4) above is at a minimum. In another embodiment, the time t is optimal when the time t is within a predefined threshold around when the cost equation is near zero. For example, the optimal time t may be any time within a time period beginning when the cost equation has decreased to a predefined threshold before the cost equation reaches zero and ending when the cost equation has increased to a predefined threshold at a time after the cost equation reaches zero. In yet another embodiment, the time t is optimal beginning when the cost equation is at a minimum and ending when the cost equation has increased to a predefined threshold. The cost equation (4) may be used in real-time to determine at what time a maintenance action is optimal, where a mixture of predicted and actual data can be used to determine the optimal time.

If, at step 418, the method 400 determines the time is optimal to schedule the maintenance of a component, the method 400 proceeds to step 420 where the method 400 schedules the component for maintenance. However, if at step 418 the method 400 determines the time does not optimize costs, the method 400 proceeds directly to step 422, where the method 400 determines whether there are any additional DG's to evaluate for maintenance issues. Revaluation of a DG for maintenance issues may be done periodically, such as once or more daily or any time a parameter has changed (e.g., upon a new bid from an installer, a new failure, or the like).

If the result of such determination at step 422 is yes, the method 400 returns to step 404; alternatively, if the result of such determination is no, the method 400 proceeds to step 424 and ends.

The foregoing description of embodiments of the invention comprises a number of elements, devices, circuits and/or assemblies that perform various functions as described. For example, the data collection module 218 is an example of a means for collecting operational data pertaining to the DG 102, and the optimization module 316 is an example of a means for optimizing the scheduling of maintenance for one or more DGs. These elements, devices, circuits, and/or assemblies are exemplary implementations of means for performing their respectively described functions.

While the foregoing is directed to embodiments of the present invention, other and further embodiments of the invention may be devised without departing from the basic scope thereof, and the scope thereof is determined by the claims that follow.

1. A method for optimizing the cost of scheduling maintenance of a distributed energy generator, at least a portion of the method being performed by a computer system comprising at least one processor, the method comprising:
obtaining information, from a controller, related to impaired operation of at least one component in a distributed energy generator, wherein the distributed energy generator comprises a plurality of components;
calculating a cost to restore non-impaired operation of the distributed energy generator;
calculating a cost of lost power due to the impaired operation of the distributed energy generator; and
determining an optimal time to schedule maintenance of the distributed energy generator based on the calculated cost to restore non-impaired operation and the calculated cost of lost power.

2. The method of claim 1, further comprising:
scheduling the distributed energy generator for maintenance service at the determined optimal time.

3. The method of claim 1, wherein the information comprises health and operational information for one or more components in the plurality of components.

4. The method of claim 1, wherein the at least one component is at least one of a photovoltaic (PV) module, a solar panel, an inverter, a micro-inverter, a solar array, or a distributed energy generator.

5. The method of claim 1, wherein calculating the cost to restore non-impaired operation comprises determining a cost of one or more components, a cost of performing a service, a transportation cost of travel to the distributed energy generator, and a predicted failure rate over time of each component in the plurality of components in the distributed energy generator.

6. The method of claim 1, wherein calculating the cost of lost power comprises determining a financial reimbursement to a customer for a period of time for an amount of power lost due to the impaired operation.

7. The method of claim 1, wherein determining the optimal time comprises minimizing a cost over time of replacing a component.

8. A computer readable medium comprising a program that, when executed by a processor, performs a method for optimizing the cost of scheduling maintenance of a distributed energy generator, the method comprising:
obtaining information, from a controller, related to impaired operation of at least one component in a distributed energy generator, wherein the distributed energy generator comprises a plurality of components;
calculating a cost to restore non-impaired operation of the distributed energy generator;
calculating a cost of lost power due to the impaired operation of the distributed energy generator; and
determining an optimal time to schedule maintenance of the distributed energy generator based on the calculated cost to restore non-impaired operation and the calculated cost of lost power.

9. The computer readable medium of claim 8, further comprising:
scheduling the distributed energy generator for maintenance service at the determined optimal time.

10. The computer readable medium of claim 8, wherein the information comprises health and operational information for one or more components in the plurality of components.

11. The computer readable medium of claim 8, wherein the at least one component is at least one of a photovoltaic (PV) module, a solar panel, an inverter, a micro-inverter, a solar array, or a distributed energy generator.

12. The computer readable medium of claim 8, wherein calculating the cost to restore non-impaired operation comprises determining a cost of one or more components, a cost of performing a service, a transportation cost of travel to the distributed energy generator, and a predicted failure rate over time of each component in the plurality of components in the distributed energy generator.

13. The computer readable medium of claim 8, wherein calculating the cost of lost power comprises determining a financial reimbursement to a customer for a period of time for an amount of power lost due to the impaired operation.

14. An apparatus for optimizing the cost of scheduling maintenance of a distributed energy generator, comprising:
a distributed generator of energy;
a controller, communicatively coupled to the distributed energy generator, for obtaining information related to impaired operation of at least one component in the distributed energy generator, wherein the distributed energy generator comprises a plurality of components; and
a scheduler, communicatively coupled to the controller, for (i) calculating a cost to restore non-impaired operation of the distributed energy generator, (ii) calculating a cost of lost power due to the impaired operation of the distributed energy generator, and (iii) determining an optimal time to schedule maintenance of the distributed energy generator based on the calculated cost to restore non-impaired operation and the calculated cost of lost power.

15. The apparatus of claim 14, wherein the scheduler schedules the distributed energy generator for maintenance service at the determined optimal time.

16. The apparatus of claim 14, wherein the information comprises health and operational information for one or more components in the plurality of components.

17. The apparatus of claim 14, wherein the at least one component is at least one of a photovoltaic (PV) module, a solar panel, an inverter, a micro-inverter, a solar array, or a distributed energy generator.

18. The apparatus of claim 14, wherein calculating the cost to restore non-impaired operation comprises determining a cost of one or more components, a cost of performing a service, a transportation cost of travel to the distributed energy generator, and a predicted failure rate over time of each component in the plurality of components in the distributed energy generator.

19. The apparatus of claim 14, wherein calculating the cost of lost power comprises determining a financial reimbursement to a customer for a period of time for an amount of power lost due to the impaired operation.

20. The apparatus of claim 14, wherein determining the optimal time comprises minimizing a cost over time of replacing a component.
